(19) United States
(12) Patent Application Publication
(10) Pub. No.: US 2019/0315336 A1
(43) Pub. Date: Oct. 17, 2019

(54) METHOD FOR CONTROLLING THE TORQUE AVAILABLE ON A HYBRID VEHICLE WHILE CHANGING GEARS

(71) Applicant: NISSAN MOTOR CO., LTD, Yokohama-shi, Kanagawa (JP)

(72) Inventors: Ludovic MERIENNE, Gif Sur Yvette (FR); Ahmed KETFI-CHERIF, Elancourt (FR)

(73) Assignee: NISSAN MOTOR CO., LTD., Yokohama-shi, Kanagawa (JP)

(21) Appl. No.: 16/302,875

(22) PCT Filed: Mar. 6, 2017
(86) PCT No.: PCT/FR2017/050494

§ 371 Date: Nov. 19, 2018

(30) Foreign Application Priority Data
May 20, 2016 (FR) 1654522

(51) Int. Cl. B60W 20/15; B60W 10/06; B60W 10/08; B60W 10/26; B60W 30/19; B60L 15/20; B60L 15/38

(52) U.S. Cl. CPC B60W 20/15; B60Y 2200/92; B60W 10/08; B60W 10/26; B60W 30/19; B60L 15/2045; B60L 15/38; B60W 2510/1005; B60W 2710/0666; B60W 2710/083; B60W 2710/248; B60W 2720/30; B60L 2240/486; B60L 2240/423; B60L 2240/527; B60L 2260/26; B60W 10/06

(57) ABSTRACT

A method for controlling the torque available during the ratio changes of a drive train consisting of a heat engine (Mth) connected to a first input shaft (4) of a gearbox (1) that can transmit the torque of same to the wheels at different transmission ratios, a first electric machine (ME) connected to a second input shaft thereof, and a second electric machine (2) connected alternately to the first or second input shaft of the gearbox, characterised in that, during the changes in the transmission ratio of the heat engine (Mth), the second electric machine (2) operates in regenerative mode and transmits all of the electric power of same to the first electric machine (ME) that uses it to compensate for the reduction in torque at the driven wheel resulting from the temporary decoupling of the heat engine during the change in ratio of same.

### TECHNICAL FIELD

The present invention relates to the control of the torque available on a hybrid vehicle during gear shifts.

More specifically, it relates to a method for controlling the torque available during the gear shifts of a powertrain made up of a combustion engine connected to a first input shaft of a gearbox which can transmit its torque to the wheels at different transmission ratios, of a first electric machine connected to a second input shaft of this gearbox, and of a second electric machine connected alternately to the first or to the second input shaft of the box.

### BACKGROUND ART

Publication WO 2014/207332 describes a hybrid transmission of this type, having a number of electrical, combustion engine and hybrid gear ratios, in which the torques from the combustion engine and from at least one electric machine are combined and applied to the wheels. Torque of combustion engine origin is transmitted to the wheels with a “combustion engine” transmission ratio, and torque from the main electric machine is transmitted with an “electric machine” ratio. During changes in the combustion engine transmission ratio in hybrid mode, the torque from the combustion engine is interrupted. The torque from the main electric machine is then controlled in such a way as to synchronize the combustion engine on its new gear ratio, while at the same time supplying torque to the wheel.

In practice, the electrical architecture of the vehicle, particularly the power available on the main electric machine, limits the contribution the latter can make during combustion engine gear changes. If the break in combustion engine torque is not well compensated for, the driver and passengers of the vehicle feel these gear shifts, like they do with a semiautomatic gearbox in which there is a break in torque.

It is therefore desirable to succeed in smoothing the break in torque felt by the driver and users of the vehicle during gear shifts.

### SUMMARY OF INVENTION

### Problems to be Solved by Invention

Reducing the available torque around the time of the gear shift does in theory address this problem. However, such a measure is unacceptable because of the negative impact it has on performance. The solution is therefore to look into increasing the torque at the wheel during the gear shifts. Any measure that consists in temporarily increasing the voltage of the onboard network offers benefits in that regard. Certain battery systems, which have the ability to modulate their output voltage using relays that place cells either in series or in parallel, could notably contribute to lessening the power hole felt during gear shifts. However, such systems have the disadvantage of making the architecture of the vehicle more cumbersome or even of causing it to need reworking.

The present invention seeks to increase the torque available during combustion engine gear changes, notably at high speed, in order to smooth their “power hole” without special adaptation of the components or electrical architecture of the vehicle.

### Means for Solving Problems

To that end, the invention proposes that, during the changes in combustion engine transmission ratio, the second electric machine should operate in regenerative mode and transmit all of its electrical power to the first electric machine which then uses it to compensate for the reduction in torque at the wheel, brought about by the temporary uncoupling of the combustion engine.

Before the uncoupling of the combustion engine and of its input shaft, the following steps are preferably performed:
cancelation of the torques of the two electric machines,
opening of the battery relays,
switching of the second electric machine into energy recovery mode, and
reduction in the torque of the combustion engine until its own power balances the power recovered by the second electric machine.

### Effect of Invention

According to the present invention, it is possible to increase the torque available during combustion engine gear changes, notably at high speed,

### BRIEF DESCRIPTION OF DRAWINGS

The present invention will be better understood from reading the following description of one particular embodiment thereof, with reference to the attached drawings.

FIG. 1 is a diagram of a hybrid architecture,

FIG. 2 groups together the gear shift curves thereof,

FIG. 3 identifies the gear ratios demanded in relation to these curves, and

FIG. 4 is the electrical diagram of the power network for this box.

### MODE(S) FOR CARRYING OUT THE INVENTION

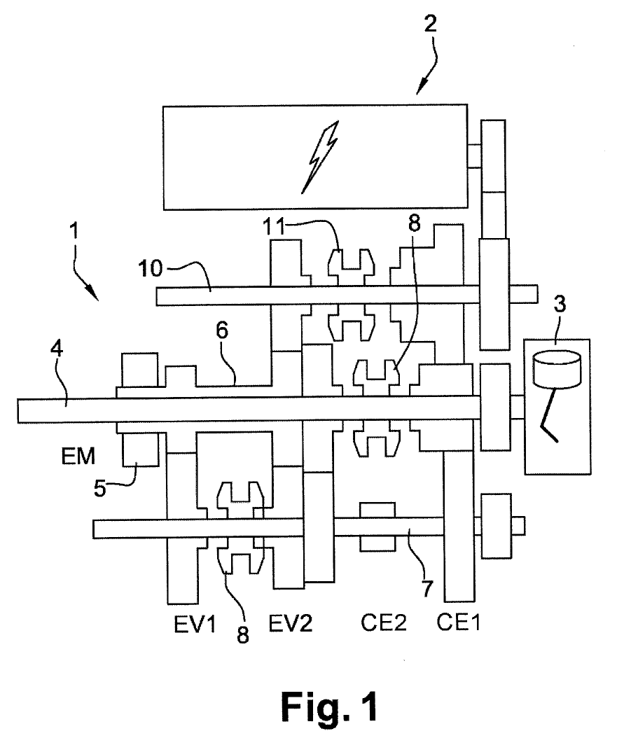

The gearbox 1 of FIG. 1 is, for example, of the “semiautomatic” type, which means that its operation is that of a manual gearbox but that the gear shifts are automated. The diagram indicates an electric machine, referred to as HSG (hybrid starter generator) 2, a combustion engine 3 on a solid primary shaft 4. Another electric machine 5, referred to as EM, more powerful than the first, is mounted on a hollow primary shaft 6. The secondary shaft of the gearbox 7 is connected to the differential (not indicated) and then to the wheels of the vehicle.

The first dog clutch 8 situated on the secondary shaft 7 allows the gear ratio of the electric machine EM 5 to be modified, independently of the rest of the box, so as to have two electric machine gear ratios EV1 and EV2 available. The second dog clutch 9, situated on the solid primary shaft 4, makes it possible to modify the gear ratio of the combustion engine 3 independently of the electric gear ratios, in order to establish two combustion engine ratios CE1 and CE4, independently of the electric machine gear ratio. The third dog clutch 11, situated on the transfer shaft 10, makes it possible to establish a third combustion engine gear ratio CE3, when moved to the right in the diagram. It is possible at any moment to choose, independently, the ratio desired on the first electric machine EM and that desired on the combustion engine CE unit and the second electric machine HSG 2. The combinations of combustion engine ratios and electric machine ratios make it possible to create hybrid ratios, denoted HEVxy, where x denotes the combustion engine ratio and y the EM ratio.

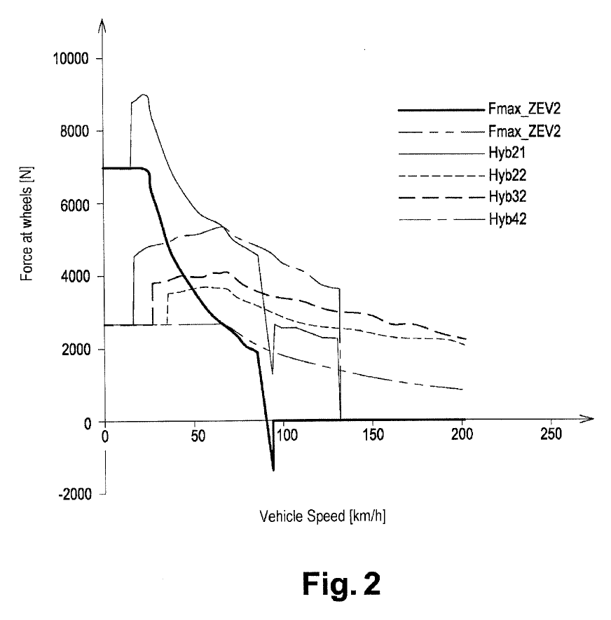

The gear shift curves for the gearbox are grouped together in FIG. 2. The box 1 makes it possible to establish two electric machine ratios ZE1 and ZE2, and four hybrid gear ratios Hyb21, Hyb22, Hyb32, Hyb42, depending on the “combustion engine ratio” and on the “electric machine ratio”. The curves plot the maximum achievable forces (force at the wheels in Newtons) in the electric and hybrid gear ratios, as a function of speed.

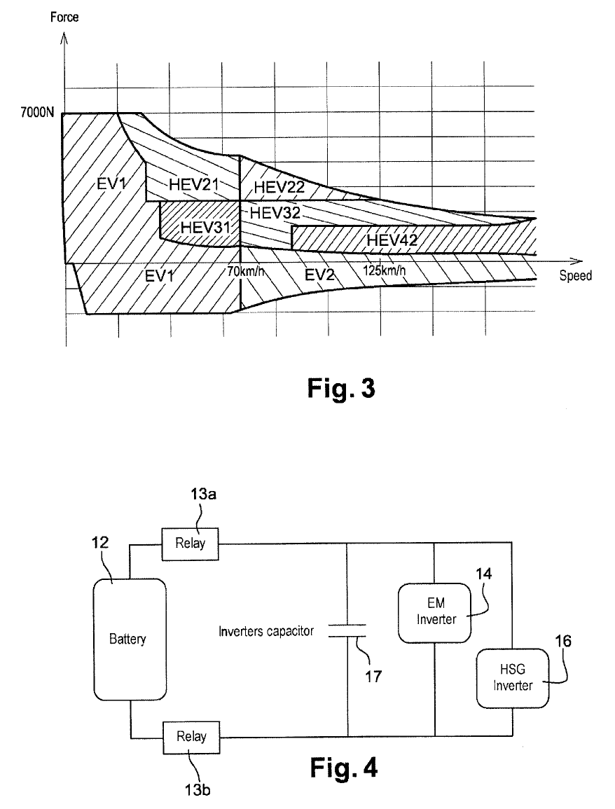

In the target application, it may be said that, by convention, the target ratio is always (irrespective of the speed of travel) an electric ratio ZEV, so long as this ratio to achieve the torque demand of the driver. By default, the ratio engaged becomes the longest hybrid ratio that makes it possible to achieve the demand. Based on this assumption, the ratios demanded may be distributed in a graph, like that of FIG. 3. That figure makes it possible to identify the gear shifts liable to occur during conventional driving. It may be seen that, for example, in foot-down acceleration, there is a shift from HEV22 to HEV32 at around 125 km/h. For this gear shift, the second combustion engine ratio needs to be disconnected from the transmission and synchronized to the new combustion engine ratio. With a battery voltage of 270V, the first machine EM is able for example to supply a power of 35 kW. The second machine HSG is able to supply a power of 25 kW, while the combustion engine CE supplies 70 kW. The overall power supplied by the box to the wheel prior to the gear shift is therefore 105 kW. After the gear shift, the box is supplying substantially the same power (give or take the variation in engine power. By contrast, during the gear shift, the combustion engine and HSG assembly is disconnected from the wheels. Only the EM is then supplying power to the wheel, namely 35 kW.

The PT (Power Train) thus suffers from a “power hole” during this gear shift. At 125 km/h, the power absorbed by the aerodynamics of the vehicle is of the order of 25 Kw. The power available for acceleration in reality drops from 80 kW to 10 kW during the gear shift. Such a drop in acceleration (by 87%) gives the driver the impression that his vehicle is no longer accelerating, despite the torque supplied by the main electric machine EM. What he feels is the same as a vehicle provided with a semiautomatic gearbox with a break in torque.

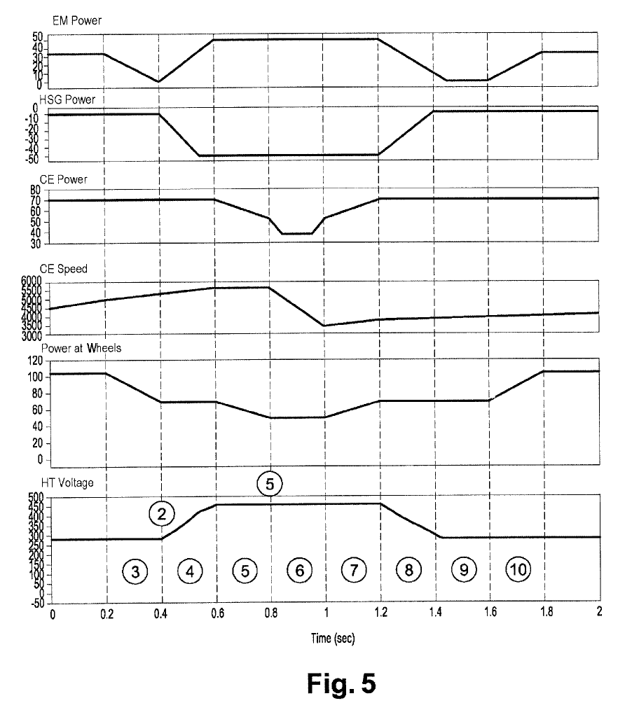

FIG. 4 shows the vehicle battery 12 connected by two relays 13a 13b to the inverters 14, 16 of the two electric machines, which are mounted in parallel on the electrical network, with an inverter capacitor 17.

The solution proposed consists in increasing the power supplied by the first main first electric machine EM during the changes in transmission ratio of the combustion engine (CE), by causing the second electric machine (HSG) to operate in regenerative mode. All of the electrical power thereof is then transmitted to the first electric machine, which uses it to compensate for the reduction in torque at the wheel brought about by the temporary uncoupling of the combustion engine. The supply voltage of the inverters is increased for that purpose. In the example described hereinabove, a power supply of 450V instead of a mean voltage of 200V allows the EM to supply around 70 kW and allows the HSG to supply around 50 kW, using the conventional components of the electrical network. The supply voltage of the inverters is therefore increased to increase the power attainable by the two electric machines during the gear change. The first electric machine (EM) thus supplies to the wheel all of the power transmitted to it by the second electric machine (HSG).

The proposed method can be applied to a gearbox such as that of FIG. 1 (in which the couplings are preferably dog clutches or claw clutches, the architecture of which is indicated schematically in FIG. 4. It consists in sequencing the following steps:
1. cancelation of the torques of the EM and of the HSG,
2. opening of the battery relays,
3. switching the HSG to regenerative mode: the HSG regulates the voltage of the inverters' capacitor to 450V and therefore supplies to the shaft of the combustion engine a negative torque (restricted to the maximum power of the HSG at 450V, namely around 50 kW) which is restored directly by the EM as a positive torque at the wheel,
4. cancelation of the torque on the primary dog clutch by reducing the torque of the combustion engine until the powers of the combustion engine and of the HSG balance: power (CE)=−power (HSG),
5. disengaging the pinion for the abandoned ratio on the primary shaft,
6. synchronizing the primary shaft with the target ratio: if this is longer than the abandoned ratio, the speed of the combustion engine is reduced by further reducing its torque (CE torque),
7. engaging the pinion representing the new ratio and increasing the torque of the combustion engine up to its maximum power,
8. cancelation of the torques of the EM and of the HSG by canceling the HSG torque a little more quickly in order to decrease the voltage of the inverters capacitor,
9. reconnecting the battery relays,
10. returning the torques of the EM and of the HSG in order to meet overall the driver's demand for torque.

When the gearbox is a dog clutch or claw clutch gearbox, the uncoupling of the combustion engine is performed by disengaging a pinion of its input shaft. Its coupling to a new gear ratio is performed by engaging a new pinion on its input shaft.

The proposed method thus comprises the following steps, prior to the uncoupling of the combustion engine and of its input shaft:
cancelation of the torques of the two electric machines,
opening of the battery relays,
switching of the second electric machine into energy recovery mode,
reduction in the torque of the combustion engine until its own power balances the power recovered by the second electric machine.

For preference, the torque of the second electric machine HSG is canceled more quickly than that of the first EM, so as to reduce the voltage across the inverters capacitor.

After it has been uncoupled, the input shaft 4 connected with the combustion engine is synchronized to the target gear ratio by controlling the torque of the combustion engine (CE), before the combustion engine is coupled to its input shaft on the new ratio. For preference, the coupling of the combustion engine is followed by an increase in torque up to its maximum power.

During the gear shift, the gearbox 1 adopts operation of the series hybrid type, in which the first electric machine EM is able to supply the wheel with exactly the power that the HSG supplies to the high-tension network. The combustion engine maintains the speed of the HSG. The relays 13a, 13b of the battery 12 are open during the change in ratio. Opening them makes it possible in a simple way to increase the voltage on the network, preventing the battery from absorbing all of the power supplied by the HSG. Switching the battery out of the circuit thus makes it possible to increase the powers that can be achieved during the gear shift.

FIG. 5 illustrates how the powers of each component, EM power, HSG power, CE power, and power at the wheel, evolve, during the gear shift, with the corresponding changes in combustion engine speed and HT (high tension) network voltage from step 1 to step 10. These curves show the benefit provided by the invention. Without compensation during the gear change, the power at the wheel would have dropped to 35 kW. By virtue of the invention, the power at the wheel is kept at 70 kW during three steps, and at 50 kW during one step. The “power hole” thus remains below 50%. The loss in acceleration is reduced, which means that the driver always feels that he has power available to accelerate.

It is furthermore still possible to increase the voltage of the network, in order to reduce the power hole still further. However, such an adaptation may require the resizing of certain components of the system, something which is not required with the simple control measures proposed by the invention.

In the case of a vehicle from the “mild hybrid” category, in which the main electric machine is intended chiefly for a “boosting” function, or for driving at low speed, it is possible to elect to limit the power available at high speed to that of the combustion engine, notably in the event of foot-down acceleration, in order not to drain the battery too quickly. In the example described, the loss in power during the gear change now represents no more than 20 kW (the difference to the maximum power of the CE equal to 70 kW). The minimum power during the gear change is equal to 50 kW.

In conclusion, the invention results in a temporary increase in the voltage of the high-tension (HT) network during the gear shifts. The major benefit of the invention is that it requires no addition to the system, if the limit on the network is kept at 450V in the example described.

1. A method for controlling the torque available during the gear shifts of a powertrain made up of a combustion engine (CE) connected to a first input shaft (4) of a gearbox which can transmit its torque to the wheels at different transmission ratios, of a first electric machine (EM) connected to a second input shaft (6) of this gearbox, and of a second electric machine (HSG) connected alternately to the first or to the second input shaft of the box,
characterized in that during the changes in combustion engine (CE) transmission ratio,
the second electric machine (HSG) switches into regenerative mode before the combustion engine is uncoupled, so as to transmit all of its electrical power to the first electric machine (EM) which uses it to compensate for the reduction in torque at the wheel which is brought about by the temporary uncoupling of the combustion engine.

2. The method for controlling torque as claimed in claim 1, characterized in that
the first electric machine (EM) supplies the wheel with the power supplied to it by the second electric machine (HSG).

3. The method for controlling torque as claimed in claim 1, characterized in that
the relays (13a, 13b) of the vehicle battery (12) are open during the gear shift.

4. The method for controlling torque as claimed in claim 1, characterized in that
it comprises the following steps, before the uncoupling of the combustion engine and of its input shaft (4):
cancelation of the torques of the two electric machines (EM), (HSG),
opening of the battery relays,
switching of the second electric machine into energy recovery mode,
reduction in the torque of the combustion engine until its own power balances the power recovered by the second electric machine.

5. The control method as claimed in claim 4, characterized in that
the torque of the second electric machine (HSG) is canceled more quickly than that of the first (EM), so as to reduce the voltage across the inverters capacitor.

6. The control method as claimed in claim 1, characterized in that
the uncoupling of the combustion engine is performed by disengaging a pinion of its input shaft (4).

7. The method for controlling torque as claimed in claim 4, characterized in that,
after it has been uncoupled, the input shaft connected with the combustion engine is synchronized to the target gear ratio by controlling the torque of the combustion engine (CE).

8. The method for controlling torque as claimed in claim 5, characterized in that the coupling of the combustion engine to its new transmission ratio is performed by engaging a new pinion on its input shaft (4).

9. The method for controlling torque as claimed in claim 7, characterized in that
the coupling of the combustion engine is followed by an increase in (CE) torque up to its maximum power.

10. The method for controlling torque as claimed in claim 1, characterized in that
the supply voltage to the inverters is increased in order to increase the power supplied by the two electric machines during the gear shift.
